(19) United States
(12) Patent Application Publication
(10) Pub. No.: US 2022/0180744 A1
(43) Pub. Date: Jun. 9, 2022

(54) SYSTEM AND METHOD FOR TASK CONTROL BASED ON BAYESIAN META-REINFORCEMENT LEARNING

(71) Applicant: Beijing DiDi Infinity Technology and Development Co., Ltd., Beijing (CN)

(72) Inventors: Yayi ZOU, Palo Alto, CA (US); Zhiwei QIN, San Jose, CA (US)

(21) Appl. No.: 17/116,062

(22) Filed: Dec. 9, 2020

(51) Int. Cl. G08G 1/081; G08G 1/01; G06K 9/62; G06N 3/08

(52) U.S. Cl. CPC G08G 1/081; G08G 1/0133; G06K 9/6297; G06K 9/6257; G06N 3/082; G08G 1/0129

(57) ABSTRACT

Methods, systems, and apparatus, including computer programs encoded on computer storage media for task control based on Bayesian Meta-Reinforcement learning. An exemplary method includes obtaining a base machine learning (ML) model trained based on historical data collected from historical tasks. The base ML model represents a prior distribution of model parameters in a neural network representing control policies. The exemplary method further includes receiving observed data from a new control task; training a task-level ML model based on the base ML model and the observed data, wherein the task-level ML model represents a posterior distribution of the model parameters; sampling, based on the posterior distribution of the model parameters, a set of the model parameters that represent a control policy; and applying the control policy in performing the new control task.

### TECHNICAL FIELD

The disclosure relates generally to systems and methods for determining a control policy, in particular, a control policy for task control based on Bayesian meta-reinforcement learning.

### BACKGROUND

Traffic signal control in intersections takes an important role in our daily life. The effort has been made to design systems that can react to the feedback from the environment in order to save the travel time of vehicles passing the intersections.

With the growing availability of traffic data collected by surveillance cameras at intersections, reinforcement learning (RL) methods for traffic signal control have gained increasing interests considering the problem can be well modeled as a Markov Decision Process (MDP). However, the direct application of standard RL to real-world traffic signal control tasks faces serious challenges. For example, standard RL techniques focused on a model-free learning framework, which follows a trial-and-error exploration manner and thus needs a large amount of data and learning time to achieve optimal performance. These demanding requirements make the standard RL techniques impractical for real-world applications. More importantly, the explorations in a long training process have no performance guarantee. It means successive trial errors may occur, which may result in severe traffic congestion and break down in the transportation system. For these reasons, a more efficient and robust machine learning technique is desired for traffic signal control tasks and other similar control tasks.

### SUMMARY

Various embodiments of the present specification may include systems, methods, and non-transitory computer-readable media for task control based on Bayesian meta-reinforcement learning.

According to one aspect, a method for task control based on Bayesian meta-reinforcement learning includes obtaining a base machine learning (ML) model trained based on historical data collected from historical tasks. The base ML model represents a prior distribution of model parameters in a neural network representing control policies. The method further includes receiving observed data from a new control task; training a task-level ML model based on the base ML model and the observed data, wherein the task-level ML model represents a posterior distribution of the model parameters; sampling, based on the posterior distribution of the model parameters, a set of the model parameters that represent a control policy; and applying the control policy in performing the new control task.

In some embodiments, the neural network includes one or more embedding layers and one or more convolutional layers, wherein at least a portion of the model parameters of the neural network are shared among different control tasks, and a structure of the neural network is adaptive according to the different control tasks.

In some embodiments, weights of the one or more embedding layers are shared across different lanes in traffic signal control tasks, and the one or more convolution layers include a plurality of 1×1 filters.

In some embodiments, the obtaining the base ML model includes training the base ML model by: initializing the base ML model; sampling one or more historical tasks from the plurality of historical tasks; for each of the sampled one or more historical tasks, obtaining a plurality of posterior distributions of the model parameters by performing gradient training based on the base ML model and the historical data collected from the historical task; and adjusting the base ML model based on the plurality of posterior distributions of the model parameters.

In some embodiments, the obtaining a plurality of posterior distributions of the model parameters includes: dividing the historical data collected from the historical task into a training set and a validation set; determining a first posterior distribution of the model parameters based on the base ML model and the training set; and determining a second posterior distribution of the model parameters based on the base ML mode, the first posterior distribution, the training set, and the validation set.

In some embodiments, the adjusting the base ML model includes: adjusting the base ML model based on a difference between (1) a first Kullback-Leibler (KL) divergence determined based on the first posterior distribution and the base ML model, and (2) a second KL divergence determined based on the second posterior distribution and the base ML model.

In some embodiments, the method further includes obtaining a starting-point model resulted from a training process of the base ML model; and the training the task-level ML model includes: training the task-level ML model based on the base ML model, the observed data, and the starting-point model, wherein the starting-point model serves as a starting point for training the task-level ML model.

In some embodiments, the applying the control policy includes: applying the control policy in the new control task to obtain newly observed data; and further training the task-level ML model based on the newly observed data to obtain a new posterior distribution of the model parameters; sampling, based on the new posterior distribution, a new set of model parameters that represent a new control policy; and applying the new control policy in the new control task.

In some embodiments, a distribution of the model parameters follows a Gaussian distribution.

In some embodiments, each of the historical tasks corresponds to a traffic signal control task at a traffic intersection, the new control task corresponds to a traffic signal control task at a new traffic intersection, and the control policy includes a traffic signal control policy.

In some embodiments, the observed data includes queue lengths of lanes at the new traffic intersection.

In some embodiments, each of the historical tasks corresponds to a navigation task towards a destination within an area, the new control task corresponds to a navigation task towards a new destination within the area, and the control policy includes a navigation policy.

According to another aspect, a system for task control based on Bayesian meta-reinforcement learning may include one or more processors and one or more non-transitory computer-readable memories coupled to the one or more processors, the one or more non-transitory computer-readable memories storing instructions that, when executed by the one or more processors, cause the system to perform operations comprising: obtaining a base machine learning (ML) model trained based on historical data collected from historical tasks. The base ML model represents a prior distribution of model parameters in a neural network representing control policies. The method further includes receiving observed data from a new control task; training a task-level ML model based on the base ML model and the observed data, wherein the task-level ML model represents a posterior distribution of the model parameters; sampling, based on the posterior distribution of the model parameters, a set of the model parameters that represent a control policy; and applying the control policy in performing the new control task.

According to yet another aspect, a non-transitory computer-readable storage medium may store instructions that, when executed by one or more processors, cause the one or more processors to perform operations comprising: obtaining a base machine learning (ML) model trained based on historical data collected from historical tasks. The base ML model represents a prior distribution of model parameters in a neural network representing control policies. The method further includes receiving observed data from a new control task; training a task-level ML model based on the base ML model and the observed data, wherein the task-level ML model represents a posterior distribution of the model parameters; sampling, based on the posterior distribution of the model parameters, a set of the model parameters that represent a control policy; and applying the control policy in performing the new control task.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an exemplary environment associated with learning control policies based on Bayesian meta-reinforcement learning in accordance with some embodiments.

FIG. 2 illustrates an exemplary block diagram of traffic signal control based on Bayesian meta-reinforcement learning in accordance with some embodiments.

FIG. 3 illustrates an exemplary neural network structure for traffic signal control based on Bayesian meta-reinforcement learning in accordance with some embodiments.

FIG. 4 illustrates exemplary methods for meta-training and meta-testing associated with traffic signal control based on Bayesian meta-reinforcement learning in accordance with some embodiments.

FIG. 5 illustrates a block diagram of a computer system apparatus for task control based on Bayesian meta-reinforcement learning in accordance with some embodiments.

FIG. 6 illustrates an exemplary method for task control based on Bayesian meta-reinforcement learning in accordance with some embodiments.

FIG. 7 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

The embodiments disclosed herein use a Bayesian version of meta-learning. Traditional meta-learning methods utilize common knowledge of existing tasks (also referred to as meta-knowledge) and learn to quickly adapt to new tasks. However, empirical studies show that traditional meta-learning methods lack robustness in adaptation and stability in the training process under complicated settings where the available meta-knowledge from existing tasks may not be sufficient for immediate quick adaptation. In real-world control tasks such as traffic signal control, where only data of limited intersections is available, it is important to have robust continual learning ability even when meta-knowledge is not sufficient yet.

In comparison, the Bayesian version of meta-learning leans a prior distribution as meta-knowledge of previously learned tasks. When comes to new tasks, the Bayesian version of meta-learning infers a task posterior based on the learned prior and data from that task. This Bayesian probabilistic foundation may effectively mitigate the instability in the training process and enhances its robustness in adaptation to a new task.

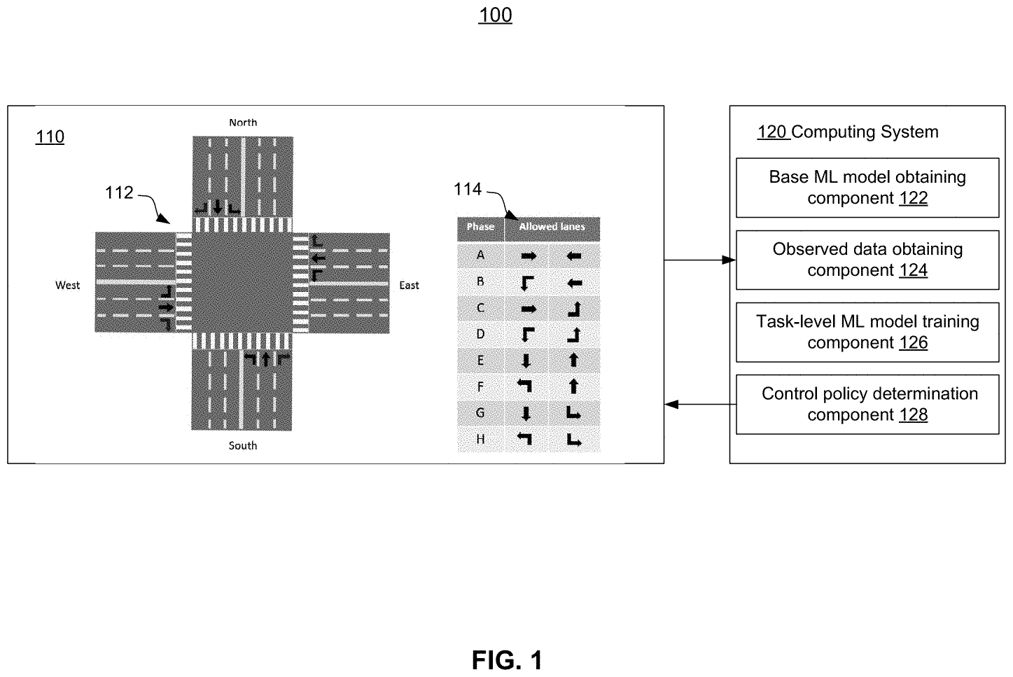

FIG. 1 illustrates an exemplary environment associated with learning control policies based on Bayesian meta-reinforcement learning in accordance with some embodiments. The exemplary environment includes a real-world environment 110 and a computing system 120. The real-world environment 110 includes a standard 4-approach intersection 112 and a table of valid phases (e.g., control signals) 114 that may be applied to control the intersection 112. The configuration of the intersection 112 is for illustrative purposes and may be replaced by other intersections with various configurations.

As shown in FIG. 1, each entering approach of the intersection 112 has a left-lane, a through-lane, and a right-lane. The control process in the intersection 112 may be modeled as a Markov decision process (MDP) L=<S, A, R, γ>, where S refers to a current state of the intersection, A refers to an action space from which a control action may be selected, R refers to a reward, and γ refers to a discount factor. In some embodiments, S is the current traffic flow of each lane at the intersection, which includes the queue length of each lane, moving speed, and other suitable factors. In some embodiments, R has a limited number of actions. Table 114 in FIG. 1 shows eight signal phases in total and each phase allows two traffic movements that do not conflict with each other. For example, phase D includes a left turn on the east-to-west lane and a right turn on the west-to-east lane. In some embodiments, R includes a negative sum of queue length of all lanes, average travel time that vehicles spend on approaching lanes (e.g., in seconds), other suitable metrics, or any combination thereof, as the reward.

With the above MDP formulation, an optimal policy for the traffic signal control task at the intersection 112 needs to be learned. Here, the policy refers to an action policy that may be represented as a neural network or a set of parameters defining the neural network. As shown in FIG. 1, the policy may be obtained from the computing system 120.

In some embodiments, the computing system 120 may be implemented in one or more networks (e.g., enterprise networks), one or more endpoints, one or more servers (e.g., server), or one or more clouds. The server may include hardware or software which manages access to a centralized resource or service in a network. A cloud may include a cluster of servers and other devices that are distributed across a network. The computing system 120 may also be implemented on or as various devices such as a mobile phone, tablet, server, desktop computer, laptop computer, etc. In some embodiments, the computing system 120 may be implemented as a single device with the exemplary components shown in FIG. 1. In other embodiments, the exemplary components of computing system 120 shown in FIG. 1 may be implemented on or as separate devices. The communication channels among the exemplary components within the computing system 120 and inputs/outputs of the computing system 120 may be over a wired connection, the internet, through a local network (e.g., LAN), or through direct communication (e.g., BLUETOOTH™, radio frequency, infrared).

In some embodiments, the computing system 120 may include a base machine learning (ML) model obtaining component 122, an observed data obtaining component 124, a task-level ML model training component 126, and control policy determination component 128. These components are for illustrative purposes, and depending on the implementation, may include fewer, more, alternative components for performing suitable functionalities.

In some embodiments, the base ML model obtaining model 122 may be configured to obtain a trained base ML model trained based on historical data collected from historical tasks, and the base ML model represents a prior distribution of model parameters in a neural network representing control policies. Assuming the use case involves traffic signal control tasks, the base ML model is trained for handling traffic signal control tasks across heterogeneous intersections for different action spaces (e.g., phase settings) and state spaces (e.g., approaching lanes). For example, the previously learned knowledge may refer to historical data collected from historical traffic signal control tasks (e.g., traffic signal control data collected from a plurality of intersections through a period of time). In some embodiments, the trained base ML model may represent a prior distribution of policy parameters in traffic signal control policies. Here, the “prior distribution” refers to the probability distribution of the policy parameters of the traffic signal control policy without knowing the actual data observed from the target intersection.

In some embodiments, a neural network may be used to represent the control policies, e.g., the traffic signal control policies. Different model parameters within the neural network may correspond to different control policies. With this setting, the above “distribution of policy parameters in traffic signal control policies” may be represented as a distribution of model parameters within the neural network. In some embodiments, the distribution of the model parameters is assumed to follow a Gaussian distribution.

In some embodiments, the base ML model may be trained within the ML model obtaining model 122 by the computing system 120, or may be obtained from a different computing system. Since the previous learned knowledge is usually large in size, the training of the base ML model may be performed on a server or a cloud. Once the base ML model is trained, it may be distributed to different computing systems like 122 to perform adaptation training based on training data observed from specific intersections. In some embodiments, the base ML model may be updated periodically based on newly collected data.

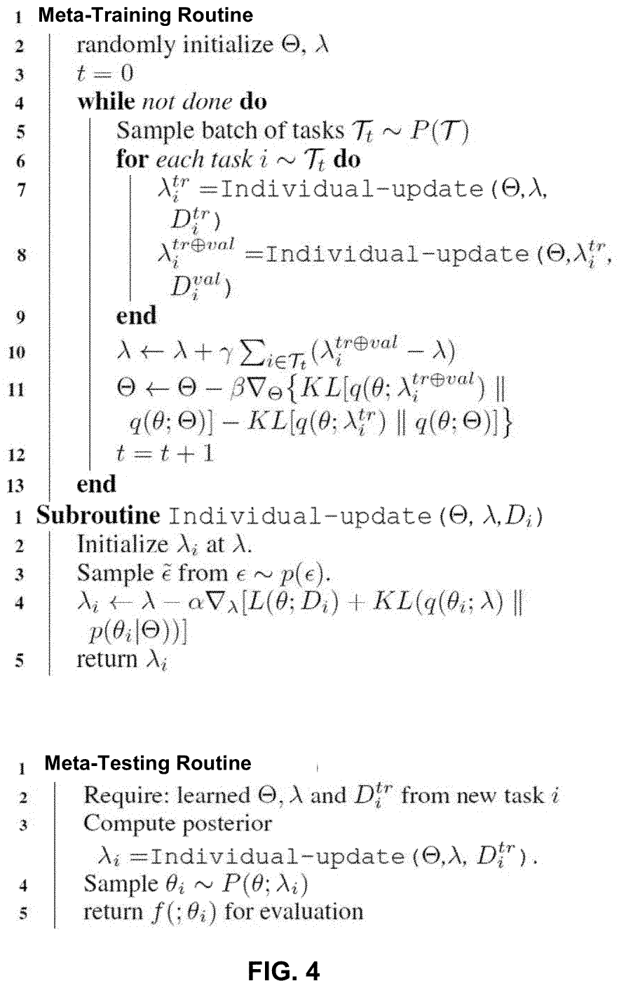

In some embodiments, the base ML model may be trained in various ways. An exemplary training process may include: initializing the base ML model; sampling one or more historical tasks from the plurality of historical tasks; for each of the sampled one or more historical tasks, obtaining a plurality of posterior distributions of the model parameters by performing gradient training based on the base ML model and the historical data collected from the historical task; and adjusting the base ML model based on the plurality of posterior distributions of the model parameters. In some embodiments, the obtaining a plurality of posterior distributions of the model parameters includes: dividing the historical data collected from the historical task into a training set and a validation set; determining a first posterior distribution of the model parameters based on the base ML model and the training set; and determining a second posterior distribution of the model parameters based on the base ML mode, the first posterior distribution, the training set, and the validation set. In some embodiments, the adjusting the base ML model includes: adjusting the base ML model based on a difference between (1) a first Kullback-Leibler (KL) divergence determined based on the first posterior distribution and the base ML model, and (2) a second KL divergence determined based on the second posterior distribution and the base ML model. Here, the base ML model corresponds to a prior distribution of the control policies at a global scale, and adjusting the model means fitting the prior distribution to the learned posterior distributions of the control policy at an individual-task level. A detailed description of the training process may refer to FIG. 4.

In some embodiments, the observed data obtaining component 124 may be configured to obtain observed data from a new control task, e.g., a target intersection. Exemplary hardware for capturing the data includes surveillance cameras. In some embodiments, the data may include the queue length of each lane at the target intersection, moving speed of the vehicles at the target intersection, and so on. The data may be observed or collected in real-time as data streams or collected periodically in small batches. The observed data may contain an inherent pattern that is unique to the target intersection and may be used to fine-tune the base-model to adapt to the target intersection.

In some embodiments, the task-level ML model training component 126 may be configured to train a task-level ML model based on the base ML model and the observed data from the observed data obtaining component 124. In some embodiments, the task-level ML model corresponds to a posterior distribution of the model parameters of the neural network representing control policies. In comparison with the “prior distribution” represented by the base ML model, the “posterior distribution” represented by the task-level ML model refers to the probability distribution of the parameters of a control policy after learning some of the observed data from the target intersection.

In some embodiments, the task-level ML model may be trained in various ways. An exemplary training process may include obtaining a starting-point model resulted from a training process of the base ML model; and training the task-level ML model based on the base ML model, the observed data, and the starting-point model, wherein the starting-point model is used as a starting point for training the task-level ML model. Here, the “starting-point model” refers to a starting point for training the task-level ML model. This starting point may be obtained as part of the training process of the base ML model. By training the task-level ML model starting from this “first ML model,” the training efficiency is significantly improved and thus the model adaptation from the base ML model to the task-level ML model for the target intersection is accelerated. In some embodiments, with the help of the “starting-point model,” the training of the task-level ML model involves a few steps of gradient leanings, usually one step.

In some embodiments, the control policy determination component 128 may be configured to determine a control policy to perform the traffic signal control task at the target intersection. For example, after the task-level ML model is trained, the posterior distribution of the model parameters are known. A set of model parameters may be sampled based on the posterior distribution, and the sampled parameters represent a control policy. In some embodiments, the determined control policy may be deployed in the field to control the traffic signals at the target intersection for a period of time, and then iteratively re-trained and improved based on newly observed data at the new intersection. This iterative process may be understood as a reinforcement learning process including: applying the control policy in the new task to obtain newly observed data; and further training the task-level ML model based on the newly observed data to obtain a new posterior distribution of the model parameters; sampling, based on the new posterior distribution, a new set of model parameters that represent a new control policy; and applying the new control policy in the new task.

It may be noted that the traffic signal control task is merely for illustrative purposes. Depending on the implementation, the above-described computing systems may be adapted to other use cases, such as navigation tasks. In that case, each of the historical tasks corresponds to a navigation task towards a destination within an area, the new task corresponds to a navigation task towards a new destination within the area, and the control policy includes a navigation policy.

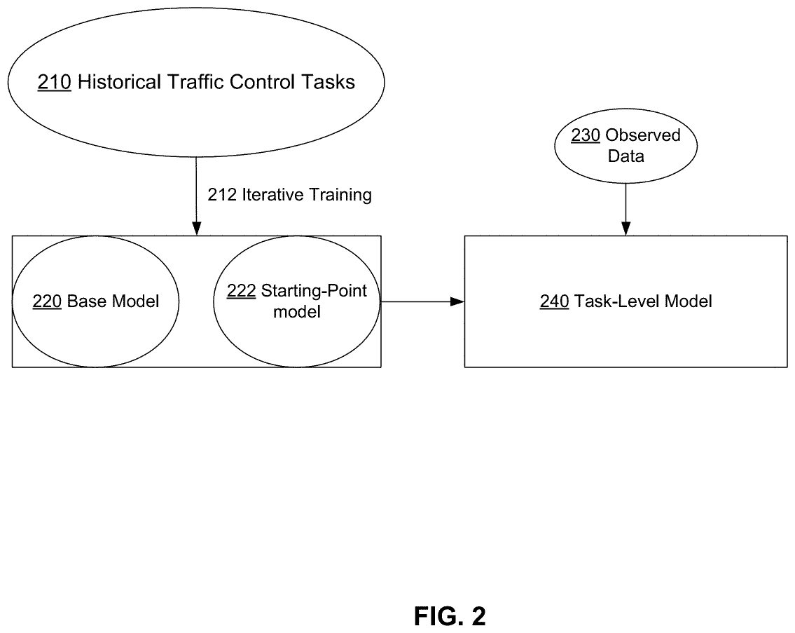

FIG. 2 illustrates an exemplary block diagram of traffic signal control based on Bayesian meta-reinforcement learning in accordance with some embodiments. For simplicity, the following description assumes the application scenario is traffic signal control. The block diagram in FIG. 2 includes two phases to determine an optimal control policy for a traffic signal control task at a target intersection. The first phase includes iterative training 212 of a base ML model 220 and a starting-point model 222 based on previously acquired knowledges, also referred to as historical traffic control tasks 210 that have been collected from a plurality of intersections. The base ML model 220 represents a prior distribution of the model parameters, and the starting-point model 222 represents a training starting-point for a posterior distribution of the model parameters. The second phase includes a training of a task-level model 240 based on observed data 230 collected from the target intersection. The target intersection may refer to a newly constructed intersection or an intersection that is upgraded to adopt the traffic signal control methods described herein. One reason for training the specific model (task-level model 240) for this target intersection based on the models (the base ML model 220 and the starting-point model 222) trained from the prior knowledge is that, the volume of the observed data collected from a new intersection is usually insufficient to directly train an accurate model. Even though the new intersection has unique characteristics, it may share some features with other intersections from which the prior knowledge was collected. Thus, the models trained based on the prior knowledge provide a reasonably accurate starting point for training the task-level model 240 specifically for the target intersection.

In some embodiments, the training of the task-level model 240 based on the base ML model 220, the starting-point model 222, and the observed data 230 may be iterative within the reinforcement learning framework. However, different from other application scenarios, significant trial errors (come with reinforcement learning) in traffic signal control tasks at intersections are not acceptable. For this reason, the iterative training 212 of the base ML model 220 and the starting-point model 222, as well as the training of the task-level model 240, both adopt Bayesian inference into the reinforcement learning by focusing on a distribution of the control model parameters, rather than learning point estimators of the model parameters. Learning the distribution provides robustness and avoid abrupt trial errors during the reinforcement learning process.

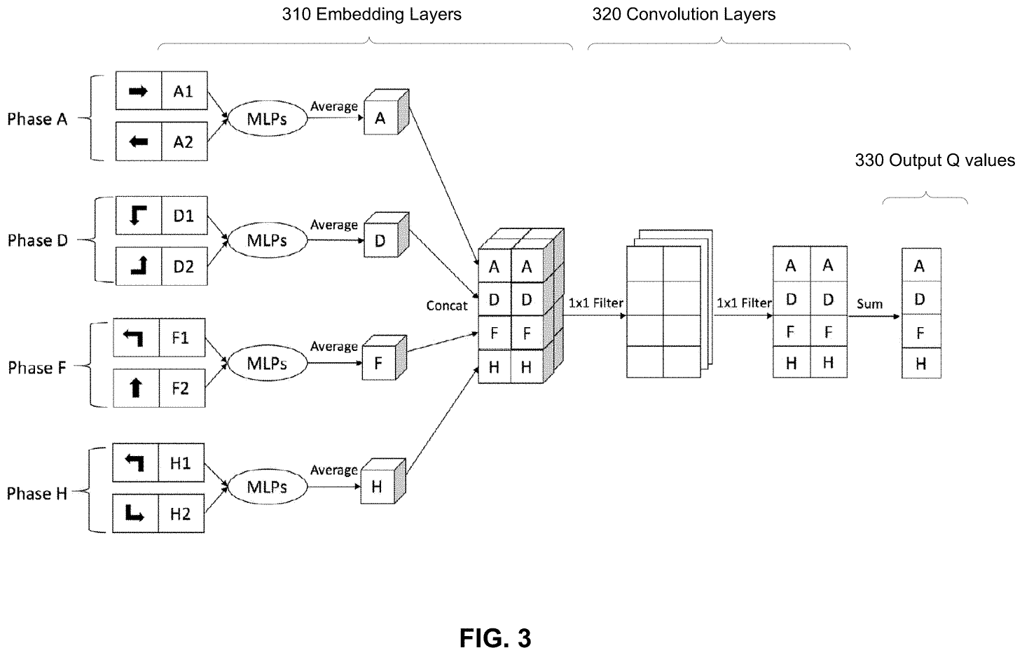

FIG. 3 illustrates an exemplary neural network structure for traffic signal control based on Bayesian meta-reinforcement learning in accordance with some embodiments. As described above, in order to train a task-level ML model to perform a traffic signal control task, a base ML model trained from prior knowledge may be acquired. In some embodiments, the base ML model and the task-level model respectively represent a prior distribution and a posterior distribution of the parameters of the control policy. In some embodiments, the control policy may be represented as a neural network, and the model parameters may refer to the parameters within the neural network. In other words, the base ML model and the task-level model are designed to learn the prior and posterior distributions of the model parameters of the neural network.

In practical scenarios, different intersections may have completely different configurations: the number and type of approaching lanes, and valid action space (e.g., phase setting, or signal control settings). For the control policy to be applicable to heterogeneous intersections, the structure of the neural network needs to be flexible and adaptive.

An exemplary neural network structure is illustrated in FIG. 3 for typical 4-phase intersections. Here, “4-phase” means that there are 4 valid phase settings in this intersection. For example, phase A indicates the east-to-west lane and the west-to-east lane are open to traffic. In some embodiments, the neural network may include one or more embedding layers 310 and one or more convolutional layers 320. The parameters of the embedding layers 310 are shared across lanes, which means the number and type of approaching lanes only affect the neural network structure rather than the parameters of embedding layers 310. The convolution layers 320 include a fixed number of 1×1 filters for feature extracting, which means the convolution layers 320 are also independent of the number and type of phases. This configuration allows the neural network to have a flexible structure depending on the number of lanes and phases in the intersection and the network parameters are shared in different intersections (i.e., different control tasks). For example, in a 6-phase intersection, the neural network may have 6 rows of neurons in the embedding layers 310 rather than the 4 rows (phase A, D, F, H) in FIG. 3, but each row shares the parameters. In other words, the parameters of the neural network are shared among different intersections or control tasks, and the structure of the neural network, such as the number of neurons in at least one of the layers in the neural network, may be adjusted depending on a number of lanes and phases in the intersections or control tasks.

FIG. 4 illustrates exemplary methods for meta-training and meta-testing associated with traffic signal control based on Bayesian meta-reinforcement learning in accordance with some embodiments. The goal of the methods is to utilize previously learned knowledge to enhance the learning process in a target intersection. In some embodiments, the first step to achieve this goal is to meta-learn a good prior (the base ML model) of the model parameters, denoted as P*=q(θ, Θ), by alternatively performing two update steps: individual update and global update. For ease of description, λᵢ is defined as an inner-learner representing the posterior distribution of the model parameters θ learned over task i, and Θ is defined as a meta-learner representing the prior distribution of the model parameters θ over a task distribution. During the individual update, starting with some prior, the inner-learner performs Bayesian fast learning to update the posterior. During the meta update, the meta-learner extracts the common knowledge over inner-learners to update the prior. During training, the plurality of inner-leaners may be used to gradually determine the starting-point model and the meta-learner. After training, the meta-learner may be referred to as the base ML model.

Referring to FIG. 4, the illustrated methods include a meta-training routine and a meta-testing routine. The meta-training routine refers to a training process of the base ML model (the individual update and global update described above) and the starting-point model described above. The meta-testing routine refers to a training process of the task-level model, which transfers the knowledge learned from historical data collected from prior intersections to new intersections.

In some embodiments, during the individual update (corresponding to the individual-update subroutine in FIG. 4), the meta-learner Θ is fixed and each inner learner λᵢ learns from the data Dᵢ of each prior task i. In some embodiments, in each intersection Iᵢ, an agent's experiences eᵢ(t)=(sᵢ(t),aᵢ(t),rᵢ(t),sᵢ(t+1)) at east timestep t are stored in Dᵢ. Then the learning process may be viewed as a Variational Inference of the posterior q (θ, λᵢ) given the prior q(θ; Θ). This may be done by gradient descent on a loss function as below:

λᵢ←λᵢ−α∇_{λ={μ}_{_{λ}}_{,σ}_{_{λ}}_{}}L^{ELBO}(λ_{λ}+\tilde{ϵ}σ_{λ};Dᵢ)

where α is the step size, \tilde{ε} is standard normal samples ε˜N(0,1). The ELBO loss is the loss function plus a KL-divergence between prior and posterior, as shown below:

L^{ELBO}(θ;Dᵢ)=L(θ;Dᵢ)+KL[q(θ;λᵢ)∥q(θ|Θ)]

From a higher level, the individual-update sub-routine accepts three input parameters: the fixed meta-learner Θ, the starting-point model λ, and data Dᵢ from a task i. During the training of the base ML model, the individual-update sub-routine may be called with historical tasks, and during the meta-testing routine, the individual-update sub-routine may be called with observed data collected from a new task. Based on the inputs, the individual-update sub-routine outputs a learned posterior distribution λᵢ of the model parameters for the task i.

In some embodiments, to speed up the learning process within the individual-update sub-routine, the gradient descent may start at the starting-point model λ rather than the meta-learner Θ. This special starting-point model λ may be meta-learned (at line 10 in the meta-training routine) and be sensitive for the ELBO loss function surface such that one or more two gradient steps may be sufficient to obtain good performance on this loss. In some embodiments, both the starting-point model λ and the meta-learner Θ may be updated in each global update step based on the results in each individual update step.

In some embodiments, during the global update (corresponding to the meta-training routine), the posteriors are fixed and updates to the meta-learner Θ may be calculated. The calculation may refer to line 11 in the meta-training routine. After the adaptation in individual-task level, global-level adaptation aims to aggregate the adaptation of each intersection Iᵢ to update the starting-point model λ of inner-learner and the meta-learner Θ.

In some embodiments, to prevent over-fitting of the meta-learner Θ, the historical data collected from a given historical task may be split into a training set and a validation set in the individual update, denoted as Dᵢ^{tr} and Dᵢ^{val}, respectively. As shown in FIG. 4, the training set and the validation set may be used for determining a first posterior distribution (denoted as λᵢ^{tr} in FIG. 4) of the model parameters based on the base ML model and the training set, and determining a second posterior distribution (denoted as λᵢ^{tr⊕val} in FIG. 4) of the model parameters based on the base model, the first posterior distribution, the training set, and the validation set. In some embodiments, the first posterior distribution λᵢ^{tr} and the second posterior distribution λᵢ^{tr⊕val} learned from each task may be used to update the starting-point model λ as well as the meta-learner Θ.

In some embodiments, the meta-learner Θ may be updated by adjusting its parameters based on a difference between (1) a first Kullback-Leibler (KL) divergence determined based on the first posterior distribution and the base ML model, and (2) a second KL divergence determined based on the second posterior distribution and the base ML model, as shown in line 11 of meta-training routine in FIG. 4.

In some embodiments, after the meta-training routine is executed for a number of iterations or after the starting-point model λ as well as the meta-learner Θ converge, the λ and Θ may be used to train task-level ML model for a target intersection with the meta-testing routine. By inputting the data observed at the target intersection i, the meta-testing routine may output a learned posterior λᵢ based on the starting-point model λ, the meta-learner Θ converge, and the observed data. Based on learned posterior λᵢ, a set of control model parameters may be sampled, as shown at line 4 in the meta-testing routine in FIG. 4. The set of control model parameters may represent a control policy that may be deployed at the target intersection, evaluated, and retrained and improved.

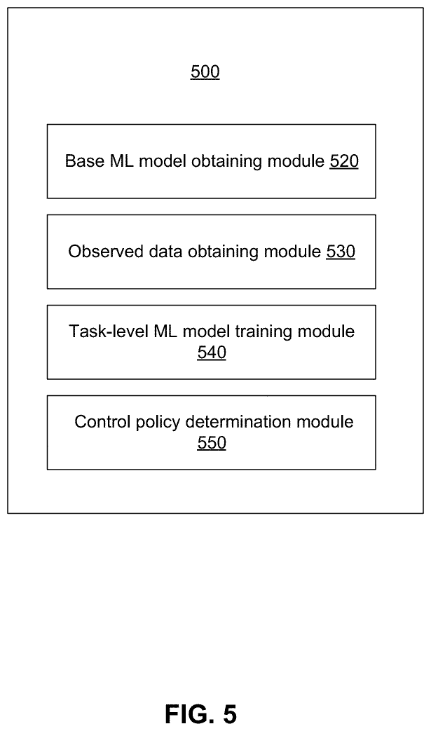

FIG. 5 illustrates a block diagram of a computer system apparatus for task control based on Bayesian meta-reinforcement learning in accordance with some embodiments. The components of the computer system 500 presented below are intended to be illustrative. Depending on the implementation, the computer system 500 may include additional, fewer, or alternative components.

The computer system 500 may be an example of an implementation of the computing system of FIG. 1. The computer system 500 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The computer system 500 may include various units/modules corresponding to the instructions (e.g., software instructions).

In some embodiments, the computer system 500 may be referred to as an apparatus for meta-learn a traffic signal control policy. The apparatus may include a base machine learning model obtaining module 520, an observed data obtaining module 530, a task-level machine learning model 540, and a control policy determination module 550. In some embodiments, the base machine learning model obtaining module 520 may be configured to obtain a base machine learning (ML) model trained based on historical data collected from historical tasks, wherein the base ML model represents a prior distribution of model parameters in a neural network representing control policies. In some embodiments, the observed data obtaining module 530 may be configured to obtain observed data from a new control task. In some embodiments, the task-level machine learning model 540 may be configured to train a task-level ML model based on the base ML model and the observed data, wherein the task-level ML model represents a posterior distribution of the model parameters. In some embodiments, the control policy determination module 550 may be configured to sample, based on the posterior distribution of the model parameters, a set of the model parameters that represent a control policy, and apply the control policy in performing the new control task.

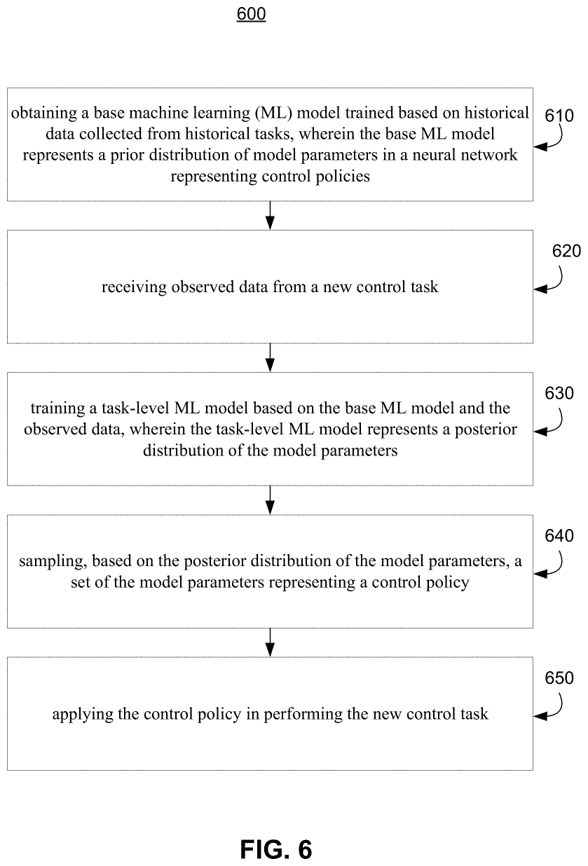

FIG. 6 illustrates an exemplary method 600 for task control based on Bayesian meta-reinforcement learning in accordance with various embodiments. The method 600 may be implemented in an environment shown in FIG. 1. The method 600 may be performed by a device, apparatus, or system illustrated by FIGS. 1-5, such as system 102. Depending on the implementation, the method 600 may include additional, fewer, or alternative steps performed in various orders or parallel.

Block 610 includes obtaining a base machine learning (ML) model trained based on historical data collected from historical tasks, wherein the base ML model represents a prior distribution of model parameters in a neural network representing control policies. In some embodiments, the neural network includes one or more embedding layers and one or more convolutional layers, wherein at least a portion of the model parameters of the neural network are shared among different control tasks, and a structure of the neural network is adaptive according to the different control tasks. In some embodiments, parameters of the one or more embedding layers are shared across different lanes in traffic signal control tasks, and the one or more convolution layers include a plurality of 1×1 filters. In some embodiments, a distribution of the model parameters follows a Gaussian distribution.

In some embodiments, the obtaining the base ML model includes training the base ML model by: initializing the base ML model; sampling one or more historical tasks from the plurality of historical tasks; for each of the sampled one or more historical tasks, obtaining a plurality of posterior distributions of the model parameters by performing gradient training based on the base ML model and the historical data collected from the historical task; and adjusting the base ML model based on the plurality of posterior distributions of the model parameters. In some embodiments, the obtaining a plurality of posterior distributions of the model parameters includes: dividing the historical data collected from the historical task into a training set and a validation set; determining a first posterior distribution of the model parameters based on the base ML model and the training set; and determining a second posterior distribution of the model parameters based on the base ML mode, the first posterior distribution, the training set, and the validation set. In some embodiments, the adjusting the base ML model includes: adjusting the base ML model based on a difference between (1) a first Kullback-Leibler (KL) divergence determined based on the first posterior distribution and the base ML model, and (2) a second KL divergence determined based on the second posterior distribution and the base ML model.

Block 620 includes receiving observed data from a new control task. In some embodiments, each of the historical tasks corresponds to a traffic signal control task at a traffic intersection, the new control task corresponds to a traffic signal control task at a new traffic intersection, and the control policy includes a traffic signal control policy, and the observed data includes queue lengths of lanes at the new traffic intersection. In some embodiments, each of the historical tasks corresponds to a navigation task towards a destination within an area, the new control task corresponds to a navigation task towards a new destination within the area, and the control policy includes a navigation policy.

Block 630 includes training a task-level ML model based on the base ML model and the observed data, wherein the task-level ML model represents a posterior distribution of the model parameters. In some embodiments, the method 600 further includes obtaining a starting-point model resulted from a training process of the base ML model; and the training the task-level ML model includes: training the task-level ML model based on the base ML model, the observed data, and the starting-point model, wherein the starting-point model serves as a starting point for training the task-level ML model.

Block 640 includes sampling, based on the posterior distribution of the model parameters, a set of the model parameters that represent a control policy.

Block 650 includes applying the control policy in performing the new control task. In some embodiments, the applying the control policy includes: applying the control policy in the new control task to obtain newly observed data; and further training the task-level ML model based on the newly observed data to obtain a new posterior distribution of the model parameters; sampling, based on the new posterior distribution, a new set of model parameters that represent a new control policy; and applying the new control policy in the new control task.

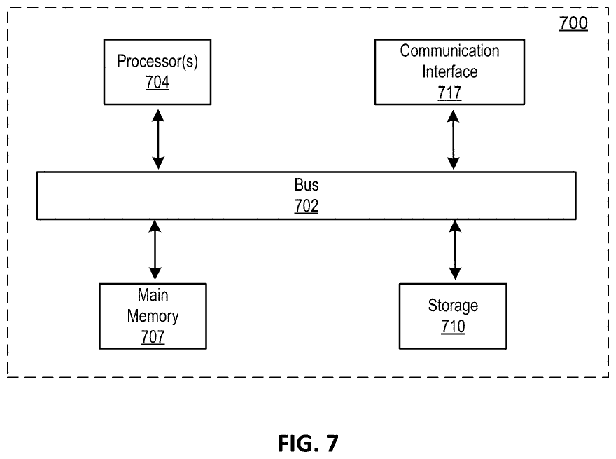

FIG. 7 illustrates an example computing device in which any of the embodiments described herein may be implemented. The computing device may be used to implement one or more components of the systems and the methods shown in FIGS. 1-6. The computing device 700 may include a bus 702 or other communication mechanism for communicating information and one or more hardware processors 704 coupled with bus 702 for processing information. Hardware processor(s) 704 may be, for example, one or more general-purpose microprocessors.

The computing device 700 may also include a main memory 707, such as a random-access memory (RAM), cache and/or other dynamic storage devices 710, coupled to bus 702 for storing information and instructions to be executed by processor(s) 704. Main memory 707 also may be used for storing temporary variables or other intermediate information during execution of instructions to be executed by processor(s) 704. Such instructions, when stored in storage media accessible to processor(s) 704, may render computing device 700 into a special-purpose machine that is customized to perform the operations specified in the instructions. Main memory 707 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 700 may implement the techniques described herein using customized hard-wired logic, one or more ASICs or FPGAs, firmware and/or program logic which in combination with the computing device may cause or program computing device 700 to be a special-purpose machine. According to one embodiment, the techniques herein are performed by computing device 700 in response to processor(s) 704 executing one or more sequences of one or more instructions contained in main memory 707. Such instructions may be read into main memory 707 from another storage medium, such as storage device 710. Execution of the sequences of instructions contained in main memory 707 may cause processor(s) 704 to perform the process steps described herein. For example, the processes/methods disclosed herein may be implemented by computer program instructions stored in main memory 707. When these instructions are executed by processor(s) 704, they may perform the steps as shown in corresponding figures and described above. In alternative embodiments, hard-wired circuitry may be used in place of or in combination with software instructions.

The computing device 700 also includes a communication interface 717 coupled to bus 702. Communication interface 717 may provide a two-way data communication coupling to one or more network links that are connected to one or more networks. As another example, communication interface 717 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may include a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be included in program codes or instructions stored in a memory (e.g., a non-transitory computer-readable storage medium described above). Such algorithm may include a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method, comprising:
obtaining a base machine learning (ML) model trained based on historical data collected from historical tasks, wherein the base ML model represents a prior distribution of model parameters in a neural network representing control policies;
receiving observed data from a new control task;
training a task-level ML model based on the base ML model and the observed data, wherein the task-level ML model represents a posterior distribution of the model parameters;
sampling, based on the posterior distribution of the model parameters, a set of the model parameters that represent a control policy; and
applying the control policy in performing the new control task.

2. The method of claim 1, wherein the neural network comprises one or more embedding layers and one or more convolutional layers.

3. The method of claim 2, wherein weights of the one or more embedding layers are shared across different lanes in traffic signal control tasks, and the one or more convolution layers comprise a plurality of 1×1 filters.

4. The method of claim 1, wherein the neural network is adaptive to different control tasks based at least on adjusting a quantity of neurons in at least one of layers in the neural network.

5. The method of claim 1, wherein the obtaining the base ML model comprises training the base ML model, wherein training the base ML model further comprises:
initializing the base ML model;
sampling one or more historical tasks from the plurality of historical tasks;
for each of the sampled one or more historical tasks, obtaining a plurality of posterior distributions of the model parameters by performing gradient training based on the base ML model and the historical data collected from the historical task; and
adjusting the base ML model based on the plurality of posterior distributions of the model parameters.

6. The method of claim 5, wherein the obtaining a plurality of posterior distributions of the model parameters comprises:
dividing the historical data collected from the historical task into a training set and a validation set;
determining a first posterior distribution of the model parameters based on the base ML model and the training set; and
determining a second posterior distribution of the model parameters based on the base ML mode, the first posterior distribution, the training set, and the validation set.

7. The method of claim 6, wherein the adjusting the base ML model comprises:
adjusting the base ML model based on a difference between (1) a first Kullback-Leibler (KL) divergence determined based on the first posterior distribution and the base ML model, and (2) a second KL divergence determined based on the second posterior distribution and the base ML model.

8. The method of claim 1, wherein the training the task-level ML model comprises:
obtaining a starting-point model resulted from a training process of the base ML model; and
training the task-level ML model based on the base ML model, the observed data, and the starting-point model, wherein the starting-point model serves as a starting point for training the task-level ML model.

9. The method of claim 1, wherein the applying the control policy comprises:
applying the control policy in the new control task to obtain newly observed data; and
further training the task-level ML model based on the newly observed data to obtain a new posterior distribution of the model parameters;
sampling, based on the new posterior distribution, a new set of model parameters that represents a new control policy; and
applying the new control policy in the new control task.

10. The method of claim 1, wherein a distribution of the model parameters follows a Gaussian distribution.

11. The method of claim 1, wherein each of the historical tasks corresponds to a traffic signal control task at a traffic intersection, the new control task corresponds to a traffic signal control task at a new traffic intersection, and the control policy comprises a traffic signal control policy.

12. The method of claim 11, wherein the observed data comprises queue lengths of lanes at the new traffic intersection.

13. A computer-implemented method, comprising:
obtaining a prior distribution of model parameters in a neural network representing task control policies, wherein the prior distribution is trained based on historical data collected from historical tasks;
receiving observed data from a new control task;
learning a posterior distribution of the model parameters based on the prior distribution and the observed data;
sampling, based on the posterior distribution of the model parameters, a set of the model parameters that represent a task control policy; and
applying the task control policy in performing the new control task.

14. The method of claim 13, wherein the neural network comprises one or more embedding layers and one or more convolutional layers, weights of the one or more embedding layers are shared across different lanes in traffic signal control tasks, and the one or more convolution layers comprise a plurality of 1×1 filters.

15. The method of claim 13, wherein the obtaining the prior distribution comprises training the prior distribution, wherein training the prior distribution further comprises:
initializing the prior distribution;
sampling one or more historical tasks from the plurality of historical tasks;
for each of the sampled one or more historical tasks, obtaining a plurality of posterior distributions of the model parameters by performing gradient training based on the prior distribution and the historical data collected from the task; and
adjusting the prior distribution based on the plurality of posterior distributions of the model parameters.

16. The method of claim 15, wherein the obtaining a plurality of posterior distributions of the model parameters comprises:
dividing the historical data collected from the historical task into a training set and a validation set;
determining a first posterior distribution of the model parameters based on the prior distribution and the training set; and
determining a second posterior distribution of the model parameters based on the prior distribution, the first posterior distribution, the training set, and the validation set.

17. The method of claim 13, wherein the training the posterior distribution of the model parameters comprises:
obtaining a starting-point distribution resulted from a training process of the prior distribution; and
training the posterior distribution of the model parameters based on the prior distribution, the observed data, and the starting-point distribution, wherein the starting-point distribution is a starting point for training the posterior distribution.

18. A non-transitory computer-readable storage medium storing instructions, when executed by one or more processors, cause the one or more processors to perform operations comprising:
obtaining a base machine learning (ML) model trained based on historical data collected from historical tasks, wherein the base ML model represents a prior distribution of model parameters in a neural network representing control policies;
receiving observed data from a new control task;
training a task-level ML model based on the base ML model and the observed data, wherein the task-level ML model represents a posterior distribution of the model parameters;
sampling, based on the posterior distribution of the model parameters, a set of the model parameters that represent a control policy; and
applying the control policy in performing the new control task.

19. The non-transitory computer-readable storage medium of claim 18, wherein the obtaining the base ML model comprises training the base ML model, wherein the training the base ML model further comprises:
initializing the base ML model;
sampling one or more historical tasks from the plurality of historical tasks;
for each of the sampled one or more historical tasks, obtaining a plurality of posterior distributions of the model parameters by performing gradient training based on the base ML model and the historical data collected from the historical task; and
adjusting the base ML model based on the plurality of posterior distributions of the model parameters.

20. The non-transitory computer-readable storage medium of claim 19, wherein the obtaining a plurality of posterior distributions of the model parameters comprises:
dividing the historical data collected from the historical task into a training set and a validation set;
determining a first posterior distribution of the model parameters based on the base ML model and the training set; and
determining a second posterior distribution of the model parameters based on the base ML mode, the first posterior distribution, the training set, and the validation set.
